(19) United States
(12) Patent Application Publication
(10) Pub. No.: US 2023/0082954 A1
(43) Pub. Date: Mar. 16, 2023

(54) PROGRAMMABLE HYBRID BATTERY BANK

(71) Applicant: Joshua Paul Hitt, REDMOND, WA (US)

(72) Inventor: Joshua Paul Hitt, REDMOND, WA (US)

(21) Appl. No.: 17/940,671

(22) Filed: Sep. 8, 2022

Related U.S. Application Data
(60) Provisional application No. 63/253,311, filed on Oct. 7, 2021.
(60) Provisional application No. 63/242,599, filed on Sep. 10, 2021.

(51) Int. Cl. H02J 7/34; H02M 3/158; H02J 7/00

(52) U.S. Cl. CPC H02J 7/345; H02M 3/1582; H02J 7/007; H02J 2207/20; H02J 2207/50

(57) ABSTRACT

Described herein are improved converters, battery banks and power circuits. Also, described herein are systems that include a multi-directional buck-boost converter and multiple voltage sources, wherein the multiple voltage sources include at least three voltage sources. Also, described herein are systems that combine a high energy-density energy storage device and a high power-density energy storage device into a single device through programmable power conversion. Also, described herein are improved buck-boost converters (such as improved DC to DC buck-boost converters). And, described herein are systems that include a buck-boost converter for multiple power sources, for multiple loads, or for both multiple power sources and multiple loads. Some embodiments include a converter that includes or is connected to a bypass circuit. And, in some embodiments, when two or more of the multiple power sources or loads experience a similar voltage, such components can be directly connected by a bypass circuit.

### CROSS-REFERENCE TO RELATED APPLICATIONS

The present application claims the benefit of priority from U.S. Provisional Patent Application No. 63/242,599, filed on Sep. 10, 2021, and entitled “BUCK-BOOST CONVERTER FOR MULTIPLE SOURCES OR MULTIPLE LOADS” and U.S. Provisional Patent Application No. 63/253,311, filed on Oct. 7, 2021, and entitled “PROGRAMMABLE HYBRID BATTERY BANK”, the entire disclosures of which applications are hereby incorporated herein by reference.

### TECHNICAL FIELD

The present disclosure relates to battery banks. The present disclosure also relates to buck-boost DC-to-DC converters, hereinafter referred to as buck-boost converters.

### BACKGROUND

Energy storage devices such as batteries and capacitors are ubiquitous in modern technology. Investment and research in the fundamental chemistries and applications of these technologies is at an all-time high and growing, with a wide variety of technologies at various stages of development and production. Yet many fundamental challenges remain regarding cost and performance constraints, and these constraints must be compensated for in application use. Such constraints include charge/discharge rates, temperature tolerance, cycle life, reliability, safety, etc.

While the limitations imposed by these constraints will be lessened over time as the underlying technology improves, the fundamental nature of these trade-offs will remain, and will continue to influence the effective application of these technologies. Improving safety, performance, and cost effectiveness through effective system design, in addition to improvements in the core energy storage technology itself, will have a profound impact on various industries.

One way to improve upon the aforesaid limitation is to use a buck-boost DC-to-DC converter, hereinafter referred to as a buck-boost converter. A buck-boost converter is a type of DC-to-DC converter that has an output voltage magnitude that is either greater than or less than the input voltage magnitude. With such converters, there are two commonly used topologies. There is the inverting topology, where the output voltage is of the opposite polarity of the input voltage. The other commonly used topology is a non-inverting topology, which often includes a buck converter combined with a boost converter. In the non-inverting topology, the output voltage is typically of the same polarity of the input voltage and it can be lower or higher than the input voltage.

### SUMMARY

Described herein are improved battery banks and power circuits (such as improved battery banks or power circuits including buck-boost converters). Also, described herein are systems that include a multi-directional buck-boost converter and multiple voltage sources, wherein the multiple voltage sources include at least three voltage sources. Also, described herein are systems that combine a high energy-density energy storage device and a high power-density energy storage device into a single device through programmable power conversion. Also, described herein are improved buck-boost converters. And, described herein are systems that include a buck-boost converter for multiple power sources, for multiple loads, or for both multiple power sources and multiple loads that may or may not include energy storage devices.

In some examples of the systems, two or more of the power sources or loads of a system may operate at or near the same voltage during periods of operation (e.g., see FIGS. 8 and 9). When this is the case, some embodiments benefit from the inclusion of a bypass circuit to temporarily bypass the buck-boost converter circuit (e.g., see FIG. 9).

This disclosure provides some technical solutions to technical problems that occur with converters, battery banks and power circuits as well as systems and methods thereof. And, this disclosure provides some technical solutions to technical problems that occur with a buck-boost converter or systems or methods thereof.

In some embodiments, a programmable hybrid battery bank combines multiple unique energy storage technologies into a single integrated device. In such embodiments, the programmable hybrid battery banks provides an improved energy storage solution over known battery banks. The programmable hybrid battery bank provides a wider range of battery options for a given application by mitigating common performance and safety constraints such as discharge rate, cycle life, etc. Integrated programmable power electronics included with the bank provide better monitoring and control capability. And, the battery bank provides a model for constructing larger energy storage systems with a simplified modular approach.

In summary, the systems and methods (or techniques) disclosed herein can provide specific technical solutions to at least overcome the technical problems mentioned in the background section and other parts of the application as well as other technical problems not described herein but recognized by those skilled in the art.

With respect to some embodiments of the programmable hybrid battery bank or derivatives thereof, disclosed herein are computerized methods for implementing such a system alone or in a computer network, as well as a non-transitory computer-readable storage medium for carrying out technical operations of the computerized methods. The non-transitory computer-readable storage medium has tangibly stored thereon, or tangibly encoded thereon, computer readable instructions that when executed by one or more devices (e.g., one or more personal computers or servers) cause at least one processor to perform a method of the system alone or in a computer network.

With respect to some embodiments, a system is provided that includes at least one computing device configured to provide the programmable hybrid battery bank or derivatives thereof alone or in a computer network. And, with respect to some embodiments, a method is provided to be performed by at least one computing device. In some example embodiments, computer program code can be executed by at least one processor of one or more computing devices to implement functionality in accordance with at least some embodiments described herein; and the computer program code being at least a part of or stored in a non-transitory computer-readable medium.

These and other important aspects of the invention are described more fully in the detailed description below. The invention is not limited to the particular assemblies, apparatuses, methods and systems described herein. Other embodiments can be used and changes to the described embodiments can be made without departing from the scope of the claims that follow the detailed description.

### BRIEF DESCRIPTION OF THE DRAWINGS

The present disclosure will be understood more fully from the detailed description given below and from the accompanying drawings of various example embodiments of the disclosure. It is to be understood that the accompanying drawings presented are intended for the purpose of illustration and not intended to restrict the disclosure.

FIG. 1 illustrates an example electronic system including a programmable hybrid battery bank, in accordance with some embodiments of the present disclosure.

FIG. 2 illustrates an electronic system including programmable hybrid battery banks connected in series to create a larger modular energy storage system, in accordance with some embodiments of the present disclosure.

FIG. 3 illustrates a system including a bidirectional buck-boost converter, in accordance with some embodiments of the present disclosure.

FIGS. 4 to 6 illustrate example aspects of improved buck-boost converters and systems including such converters, in accordance with some embodiments of the present disclosure. Specifically, FIG. 4 illustrates a system including a hex-directional buck-boost converter using a supercapacitor (labeled a “SCAP” in the drawings). The hex-directional buck-boost converter also uses a battery, a load, and a power source (e.g., a charging source). Also, FIG. 5 illustrates a system including an n-source buck-boost converter, in accordance with some embodiments of the present disclosure. And, FIG. 6 illustrates another system including an n-source buck-boost converter, in accordance with some embodiments of the present disclosure.

FIG. 7 illustrates is a block diagram of example aspects of an example computer system, in accordance with some embodiments of the present disclosure.

FIG. 8 illustrates another system including a hex-directional buck-boost converter, in accordance with some embodiments of the present disclosure.

FIG. 9 illustrates another system including a hex-directional buck-boost converter as well as a bypass circuit, in accordance with some embodiments of the present disclosure.

FIG. 10 illustrates a method, in accordance with some embodiments of the present disclosure.

### DETAILED DESCRIPTION

Described herein are improved battery banks or power circuits. Also, described herein are systems that combine a high energy-density energy storage device and a high power-density energy storage device into a single device through programmable power conversion. In some embodiments, the programmable hybrid battery bank combines multiple unique energy storage technologies into a single integrated device. In such embodiments, the programmable hybrid battery bank provides an improved energy storage solution over known battery banks. The programmable hybrid battery bank provides a wider range of battery options for a given application by mitigating common performance and safety constraints such as discharge rate, cycle life, etc. Integrated programmable power electronics included with the bank provides better monitoring and control capability. And, the bank provides a model for constructing larger energy storage systems with a simplified modular approach.

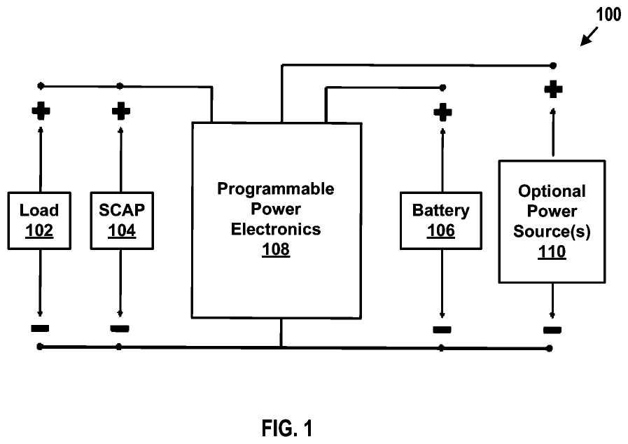

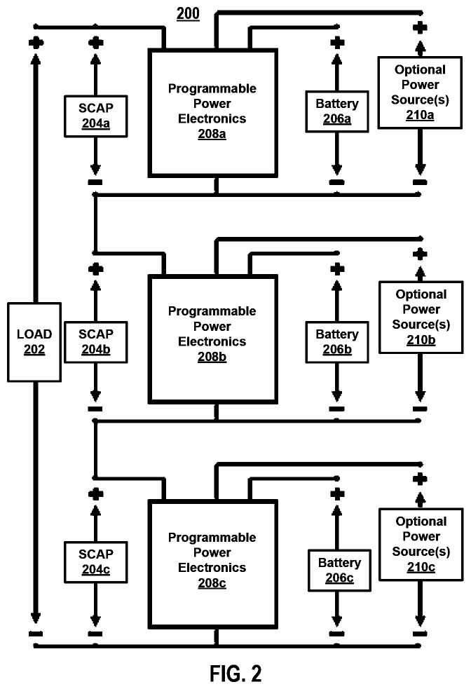

In some embodiments, the programmable hybrid battery bank (e.g., see programmable hybrid battery banks 100 and 200 shown in FIGS. 1 and 2) combines a high energy-density energy storage device and high power-density energy storage device into a single device through programmable power conversion. As shown in the embodiment of bank 100 illustrated in FIG. 1, a load 102 is connected to positive and negative output terminals, which are directly connected to an energy storage device with a high power density, in this case a supercapacitor 104. The supercapacitor is labeled as a “SCAP” in the FIG. 1. In some embodiments, the supercapacitor includes a single cell or multiple cells combined in series or in parallel configurations.

In the embodiment shown in FIG. 1, of which there are many alternatives, use of the supercapacitor provides numerous advantages over a battery including high surge power capability, high cycle life, variable voltage capability, protection against thermal runaway, etc. Charging and discharging of battery 106 is controlled by built-in power electronics, such as the programmable power electronics 108 shown in FIG. 1.

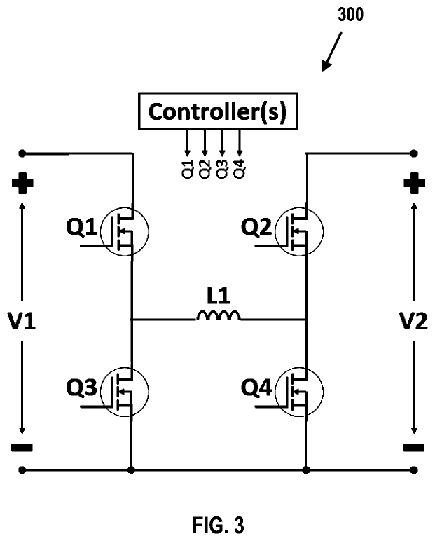

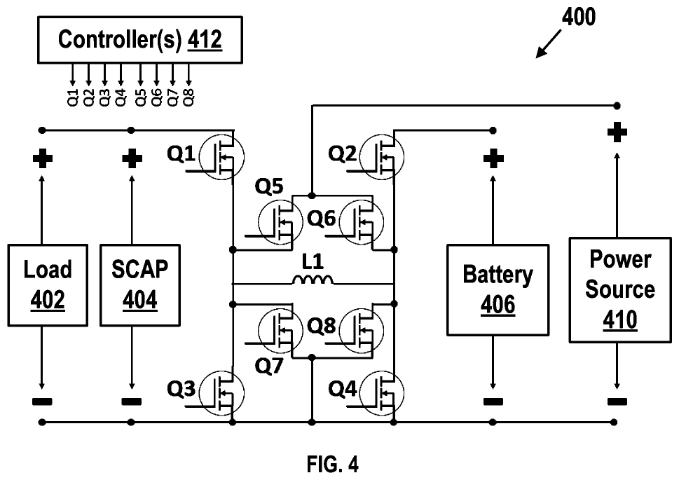

In the embodiment shown in FIG. 1, the battery 106 and supercapacitor 104 can operate at different or similar voltages and power is converted between these two components by the built-in power electronics, shown as programmable power electronics 108 in FIG. 1. In some embodiments, power is converted between the components using a DC-DC buck-boost converter in the power electronics, which can be multi-directional (e.g., see the buck-boost converters 300, 400, 500, and 600 shown in FIGS. 3 to 6 respectively). In other words, in such examples, the built-in power electronics shown as programmable power electronics 108 includes a DC-DC buck-boost converter. An example of a bidirectional buck-boost converter 300 that can implement a power conversion in the built-in power electronics is shown in FIG. 3. Examples of multi-directional buck-boost converters, beyond two directions, which can implement the power conversions in the built-in power electronics are shown in FIGS. 4, 5 and 6 (e.g., see converters 400, 500, and 600).

The power electronics operation, e.g., whether it is the power electronics shown in FIG. 1 or 2, is customizable through circuit design and/or software and is driven by a logic controller that can monitor various internal and external parameters (e.g., voltages, temperatures, external commands, etc.). The charge state of the system (such as the system shown in FIG. 1 or 2) is determined by a combination of monitored voltages and other parameters, and the power electronics are programmed to a default behavior based on the charge state and/or other monitored parameters, which can be reprogrammed or monitored or modified in real-time. Such functionality can be implemented through the programmable power electronics 108 shown in FIG. 1 or the programmable power electronics 208a, 208b, and 208c shown in FIG. 2.

The loads of each bank, e.g., see loads 102 and 202, as well as one or more optional power sources such as one or more charging voltage sources (e.g., see optional power sources 110 and 210a, 210b, and 210c) and/or additional loads can also be connected through the power electronics. In some embodiments, power can be transferred in multiple directions when using a multi-directional DC-DC buck boost converter (e.g., see converter 400 shown in FIG. 4) as a converter having a battery to supercapacitor direction, supercapacitor to battery direction, power source(s) to supercapacitor direction, power source(s) to battery direction, supercapacitor to power source(s) direction, battery to power source(s) direction, between different power sources direction, etc.). In such embodiments, the power source(s) can include or be one or more charging sources. Additional converter directions as shown in FIGS. 4, 5, and 6 enable numerous possible configurations including secondary backup functionality for a particular power source (such as a particular charging source), and/or the ability to add on additional energy storage. As an example, the purpose of this can be to add secondary batteries for additional energy, including different types of batteries with different performance features. Another example would be to store power from an intermittent power source when it is available, such as from a solar panel.

Large battery systems including of smaller batteries connected in series and/or parallel are used for a wide variety of applications. These include motive applications, large backup power systems, grid-scale energy storage, renewable energy storage, and many other applications. Batteries in the aforementioned applications should be closely monitored and controlled for optimal performance and safety. Depending on the chemistry, this usually includes cell balancing and closely managed charge and discharge performance. Even sophisticated system designs fail, leading to premature battery life and potentially dangerous thermal runaway conditions.

Multiple programmable hybrid power batteries can also be connected in series and/or parallel for larger energy storage needs, offering several advantages over comparable single-technology installations. The hybrid design of programmable hybrid battery bank 100 shown in FIG. 1, includes a supercapacitor (labeled “SCAP 104”) and a battery (labeled “Battery 106”). In some embodiments, the hybrid design can be replicated to form a design with multiple supercapacitors and batteries, e.g., see programmable hybrid battery bank 200 shown in FIG. 2. In FIG. 2, each supercapacitor is labeled “SCAP” and each battery being labeled “Battery”, e.g., see SCAPs 204a, 204b, and 204c and batteries 206a, 206b, and 206c. In these embodiments, supercapacitors can be much more resilient while also providing significantly higher power density.

As shown in FIG. 2, the hybrid design of the programmable hybrid battery bank 200 includes supercapacitors and batteries and are connected in series (e.g., see SCAPs 204a, 204b, and 204c and batteries 206a, 206b, and 206c). This allows the supercapacitors to act as a power buffer to improve system power, life, and safety. The batteries are subject to reduced short-term power requirements with fully programmable charge and discharge rates to ensure safer operations. Balancing of the battery cells is eased and becomes self-contained at a modular level. Each battery is separated from the others through the power electronics of each module, which independently manage battery health per defined parameters.

In some embodiments, such as the embodiment shown in FIG. 2, the independent operation and control of each module (including a supercapacitor, a separate programmable power electronics, a battery, and optional power source(s) that can include one or more optional charging sources) introduces the capability for multiple layers of automated or semi-automated decentralized control, simplifying integration requirements for larger installations, reducing control complexity, and improving overall system performance. Detailed monitoring at the module level allows for the quick identification of anomalies, providing multiple levels of visibility for safety and oversight. In these installations each module can be connected to an isolated power source (such as an isolated charging source) to ensure that potential imbalances between modules are self-corrected, and charging parameters are adjustable to optimize performance. Serviceability is also improved, as individual battery modules can safely be serviced or replaced with little or no impact on the larger system.

Turning to FIGS. 3 to 6, shown are converters 300, 400, 500, and 600, that can be integrated with the programmable power electronics 108 and 208a to 208c shown in FIGS. 1 and 2, respectively. Specifically, FIG. 3 illustrates a system including a bidirectional buck-boost converter 300. For another example of a bidirectional buck boost converter, see U.S. Pat. No. 5,734,258A. Some embodiments extend the bidirectional buck-boost converter to compensate for multiple loads and/or for multiple power sources (such as three or more power sources and/or loads).

FIG. 4 shows the topology of the bidirectional buck-boost converter extended into hex directional buck-boost converter 400. In some embodiments, a system includes a circuit design approach that extends a bidirectional buck-boost converter to three or more power sources and/or loads. Extending bidirectional conversion technology from between two sources to three expands the integration possibilities of various energy storage technologies and other DC power systems. For instance, it allows multiple energy storage technologies to be integrated together with another power source and/or load. With such embodiments, high power technology can be paired with high energy technology to provide an energy storage device that has improved combined power and energy performance for a given application. The power and energy performance is improved to an extent that oversizing battery energy capacity for the sake of increasing short-term power capability is not needed. Also, safety, cost, life, and other considerations are improved in such embodiments.

In some embodiments, a system includes and integrates a supercapacitor and a battery. Batteries provide high energy density, but are often constrained in power, cycle life, safety, cost, and other factors. These tradeoffs vary with the type of battery selected. Supercapacitors, on the other hand, have lower energy density than batteries but tend to outperform batteries in the other mentioned areas. A system with a battery and a supercapacitor can allow for adjusting the system to obtain a determined balance of such factors (e.g., factors including power output, cycle life, safety, and cost constraints). In some embodiments, active power conversion is used to integrate a battery and a supercapacitor, as supercapacitors and batteries have different operating voltage profiles—which could also be different from the power source voltage, or more specifically, a charging source voltage. E.g., see power source 410 shown in FIG. 4.

The hex directional buck-boost converter 400 shown in FIG. 4 includes a load 402, a supercapacitor 404, a battery 406, and a power source 410 (which can be a separate power source). The hex directional buck-boost converter 400 uses a multi-directional buck-boost conversion circuit for charging and internal power transfers. The hex directional buck-boost converter 400 can provide improved system performance over using either supercapacitor 404 or battery 406 separately. Such a circuit also breaks the direct connection between the battery 406 and the load 402. This allows some embodiments to include logic control of the battery charging and discharging to further adjust performance and safety factors provided by the system (e.g., see the one or more controllers shown in FIG. 4 and labeled as “Controller(s) 412”). As shown in FIG. 4, the one or more controllers 412 can control the output of each of the field effect transistors (FETs) of the system (e.g., see the controller(s) labeled “Controller(s)” and the FETs labeled “Q1”, “Q2”, “Q3”, “Q4”, “Q5”, “Q6”, “Q7”, and “Q8”). As shown in FIG. 4 as well as FIGS. 3, 5, 6, 8 and 9, the FETs are n-type FETs. However, it is to be understood that in some other embodiments the FETs can be p-type FETs or a combination of n-type and p-type FETs.

It is to be understood, that the system shown in FIG. 4 can be altered for different applications and power conversion functionality. As shown, and as in embodiments related to the system shown in FIG. 4, the system includes one or two field effect transistors (FETs) directly upstream of an inductor (e.g., see the inductor labeled “L1” and the FETs labeled “Q5” and “Q6” shown in FIG. 4). Also, shown in FIG. 4 are additional upstream FETs (e.g., see the FETs labeled “Q1” and “Q2”). The directly upstream FETs (such as the FETS labeled “Q5” and “Q6”) and the inductor are integrated in the system such that a power source can be added and used to charge the battery 406 and/or the supercapacitor 404. Also, as shown in FIG. 4, in some embodiments, additional downstream FETs (e.g., see the FETs labeled “Q7” and “Q8”) can be removed if the upstream FETs are properly matched to additional downstream FETs (e.g., see the FETs labeled “Q3” and “Q4”).

In some embodiments, such as the example system shown in FIG. 4 and systems related to the system shown in FIG. 4, six directions of power conversion are possible, each with buck-boost functionality. The directions of power conversion can be controlled by the controller(s) 412 of the system. The six directions of power conversion include power source 410 to battery 406, power source 410 to supercapacitor 404 and load 402, battery 406 to power source 410, battery 406 to supercapacitor 404 and load 402, supercapacitor 404 and load 402 to battery 406, and supercapacitor 404 and load 402 to power source 410.

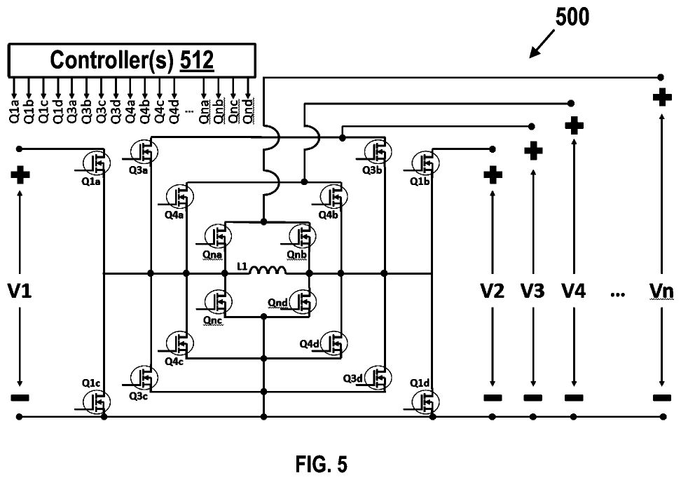

As mentioned, some embodiments extend the bidirectional buck-boost converter to compensate for multiple loads and/or for multiple power sources (such as three or more power sources and/or loads). FIG. 5 shows the topology of the bidirectional buck-boost converter extended into a n-source buck-boost converter 500. In other words, FIG. 5 illustrates the topology of the bidirectional buck-boost converter extended into a buck-boost converter for multiple power sources (such as a number of power sources well beyond three power sources). As shown in FIG. 5, in some embodiments, the possible directions of power transfer can become a factorial of the number of power sources and/or loads. The system shown in FIG. 5 includes multiple power sources (e.g., see the power sources labeled “V2”, “V3”, “V4”, and “VN”, and the load labeled “V1”). Conversely, a related system can have multiple loads (e.g., if “V2”, “V3”, “V4”, and “VN” are considered loads and “V1” is considered a power source). Also, shown in FIG. 5, controller(s) 512 control the many different directions of power transfer of the system via control of the FETs of the system (e.g., see FETs labeled “Q1a”, “Q1b”, “Q1c”, “Q1d”, “Q3a”, “Q3b”, “Q3c”, “Q3d”, “Q4a”, “Q4b”, “Q4c”, “Q4d”, “Qna”, “Qnb”, “Qnc”, and “Qnd”).

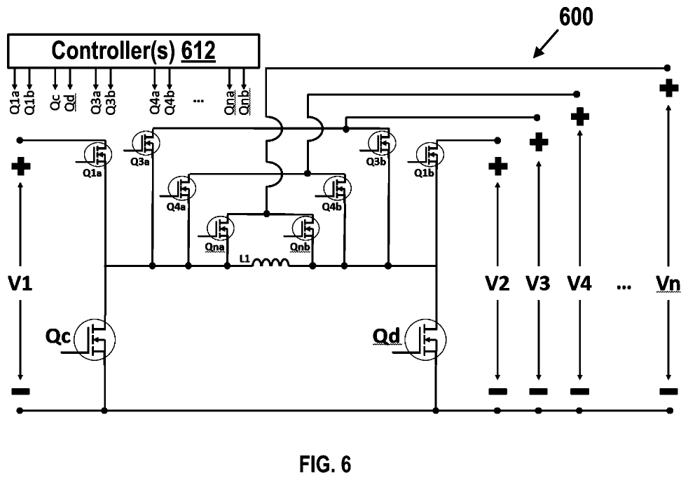

FIG. 6 shows the topology of the bidirectional buck-boost converter extended into a n-source buck-boost converter 600 that has a reduced number of FETs compared to the converter 500 shown in FIG. 5. To reduce the number of FETs of the circuit, proper application sizing can combine the lower FETs into as few as two components (as shown if FIG. 6). This reduces circuit complexity. In the system of FIG. 6, the FETs labeled “Q1c”, “Old”, “Q3c”, “Q3d”, “Q4c”, “Q4d”, “Qnc”, and “Qnd” have been replace with two FETs labeled “Qc” and “Qd”. Also, shown in FIG. 6, controller(s) 612 control the many different directions of power transfer of the system via control of the FETs of the system.

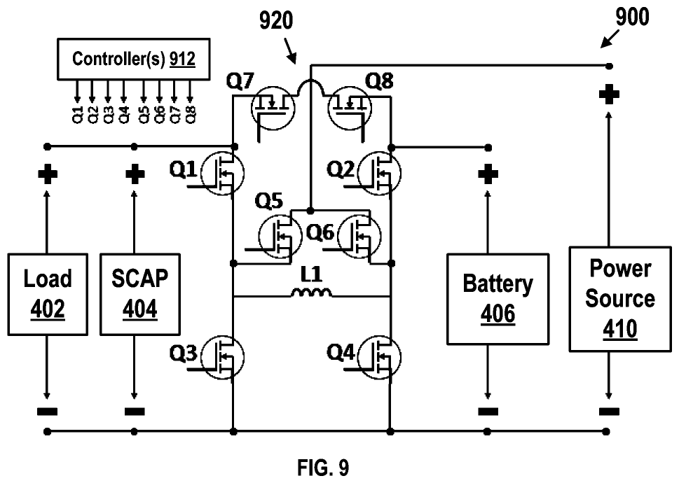

In some embodiments, such as the embodiments shown in FIGS. 5 and 6, a multi-directional buck-boost converter for regulating power flow between two of three or more voltage sources (in which the voltage sources can be power sources, loads, or a combination thereof) can include a bidirectional buck-boost converter between first and second voltage sources of such voltage sources. In some of such examples, two switching devices are connected in series between the positive and negative poles of the first and second voltage sources. Also, in some of such examples, the two switching devices are coupled by an inductor connected to an intermediate junction of the pair of switching devices and other similar pairs of switching devices of the converter. Also, in some of such embodiments, a positive pole of one or more additional voltage sources (in which the additional voltage sources can be power sources, loads, or a combination thereof) can be coupled to one or more junctions of the inductor using switching devices. And, the negative poles of each additional voltage source can be coupled together so that the switching devices can be operated by a controller to conduct current between at least two of the voltage sources of the converter and selected to do so in one of three or more directions. Also, in some of such embodiments and other embodiments (e.g., see FIG. 9), a multi-directional buck-boost converter includes one or more bypass circuits. In such examples, a bypass circuit includes one or more switching devices coupling the positive poles of any two voltage sources (in which the voltage sources can be power sources, loads, or a combination thereof) so that current can be conducted between the two voltage sources without being conducted through the inductor.

Some embodiments of the n-source buck-boost converter offers numerous opportunities to integrate multiple (such as more than two) power sources and/or loads. Such embodiments can help to advance the use and adoption of energy storage devices, renewable energy and could improve power electronics integration. Such embodiments can improve on the concept of bidirectional power conversion by extending it beyond two directions and two power sources and/or loads, adding significant new capabilities with a modest increase in complexity.

The embodiments described herein can be adapted to various permutations depending on application needs. For example, some connections can be unidirectional, others can be bidirectional, and yet others can be n-directional (or can be multi-direction in general). This can be accomplished through logic control and/or modest tweaks to the circuit design by those skilled in the art. The voltage levels can vary across the various devices and voltage sources within the tolerances of the selected components. Relays can be added for ground isolation if appropriate, and numerous other circuit design techniques can be incorporated. Another key capability is that each connection can be logic controlled, enabling opportunities for software and/or hardware customization and control.

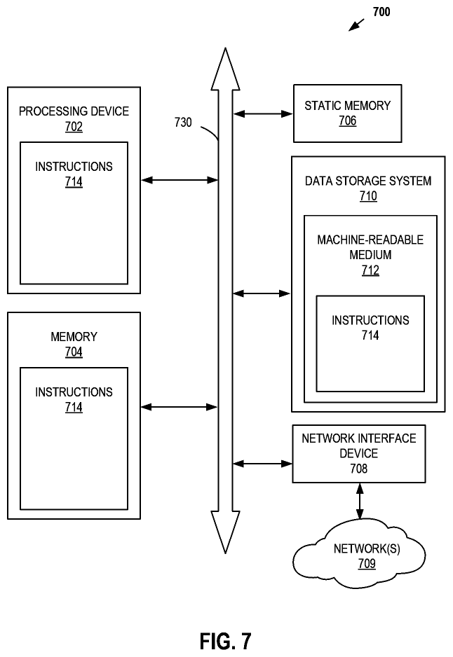

In embodiments with software and/or hardware customization and control, the system includes a computing device (such as computing device 700 shown in FIG. 7). For example, the controllers described herein (such as controller(s) 412, 512, 612, 812, and 912) can include the computing device 700. The computing device 700 includes a processing device 702, a main memory 704 (e.g., read-only memory (ROM), flash memory, dynamic random-access memory (DRAM), etc.), a static memory 706 (e.g., flash memory, static random-access memory (SRAM), etc.), and a data storage system 710, which communicate with each other via a bus 730. The processing device 702 can include one or more general-purpose processing devices such as a microprocessor, a central processing unit, or the like. More particularly, the processing device 702 can be a microprocessor or a processor implementing other instruction sets, or processors implementing a combination of instruction sets. The processing device 702 can also include one or more special-purpose processing devices such as an application specific integrated circuit (ASIC), a field programmable gate array (FPGA), a digital signal processor (DSP), network processor, or the like. The processing device 702 can be configured to execute instructions 714 for performing the operations discussed herein. Such a computer system can further include a network interface device 708 to communicate over LAN/WAN network(s) 709. The data storage system 710 can include a machine-readable storage medium 712 (also known as a computer-readable medium) on which is stored one or more sets of instructions (such as instructions 714) or software embodying any one or more of the methodologies or functions described herein. The instructions 714 can also reside, completely or at least partially, within the main memory 704 and/or within the processing device 702 during execution thereof by the computer system, the main memory and the processing device also constituting machine-readable storage media.

While the machine-readable storage medium 712 can be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

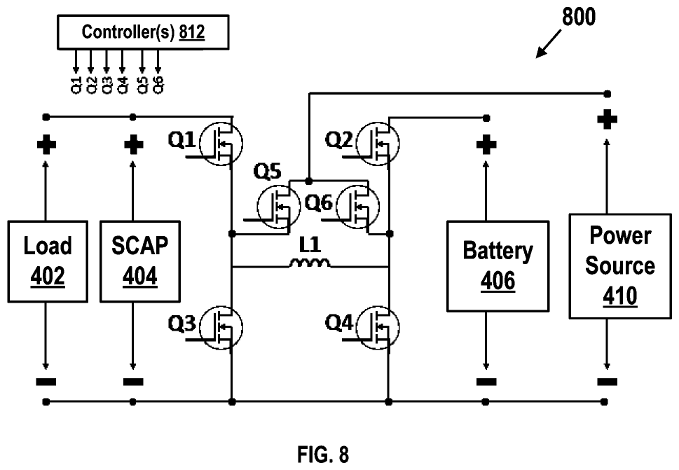

In some embodiments, two or more of the power sources or loads may operate at or near the same voltage during periods of operation (e.g., see FIGS. 8 and 9). When this is the case, it may be beneficial to temporarily bypass the buck-boost converter circuit. There can be multiple benefits in bypassing the buck-boost converter in this manner. For example, bypassing the converter eliminates heat losses from the power conversion process. Also, bypassing the buck-boost converter may allow the buck-boost controller to be temporarily turned off or put into low power mode, further reducing parasitic losses. And, directly connecting two or more sources or loads in this manner allows for another source or load to simultaneously charge or discharge the connected sources or loads through the buck-boost converter. Thus, in some embodiments of the systems described herein, the converter includes or is connected to a bypass circuit and the multiple power sources or loads of similar voltage can be directly connected by the bypass circuit to avoid use of the converter.

FIG. 8 illustrates another system including a hex-directional buck-boost converter 800. In this example embodiment there is no bypass circuit. FIG. 8 shows the topology of the hex-directional buck-boost converter that has a reduced number of FETs compared to the converter shown in FIG. 4. And, to reduce the number of FETs of the circuit, proper application sizing can combine the lower FETs into as few as two components (as shown in FIG. 8). This reduces circuit complexity. In the system of FIG. 8, the FETs labeled “Q7” and “Q8” have been removed to reduce circuit complexity. Similar to converter 400, converter 800 includes load 402, supercapacitor 404, battery 406, and power source 410. With the reduced circuit complexity, the controller 812 of the converter 800 also has reduced complexity relative to controller(s) 412 of converter 400.

FIG. 9 illustrates another system including a hex-directional buck-boost converter 900 as well as a bypass circuit 920. FIG. 9 shows the topology of the hex-directional buck-boost converter 900 that has a reduced number of FETs compared to the converter shown in FIG. 4 (similar to the converter shown to FIG. 8). And, FIG. 9 shows how the FETs labeled “Q7” and “Q8” can be moved in the converter to implement a bypass circuit 920. Also, similar to converter 400, converter 900 includes load 402, supercapacitor 404, battery 406, and power source 410. The converter 900 also includes the controller 912 of the converter 800 that controls the FETs of the converter 900 and the bypass circuit 920.

In the example converter 900 shown in FIG. 9, a bypass circuit 920 including the FETs labeled “Q7” and “Q8” is located between the positive voltage terminals of supercapacitor 404. And, in such arrangement, battery 406 can be engaged by the system when the supercapacitor 404 and the battery 406 equalize in voltage and meet other selected criteria (e.g., discharge rate). The battery 406 can then directly power the load 402 connected to the supercapacitor 404 without incurring buck-boost conversion losses. Further, another available voltage source, such as source 410, can be used by the buck-boost converter to simultaneously charge both the supercapacitor 404 and the battery 406 without disconnecting the battery 406 from the load 402.

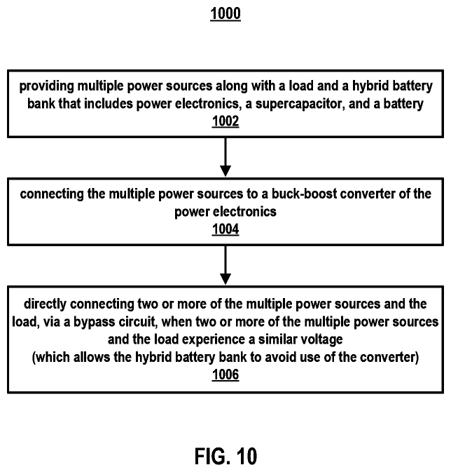

FIG. 10 illustrate a method 1000 in accordance with some embodiments of the present disclosure. The method 1000 commences with step 1002 that includes providing multiple power sources along with a load and a hybrid battery bank that includes power electronics, a supercapacitor, and a battery. The power electronics include a buck-boost converter that is a multi-directional buck-boost converter. At step 1004, the method 1000 continues with connecting the multiple power sources to the buck-boost converter. At step 1006, the method 1000 continues with directly connecting two or more of the multiple power sources and the load, via a bypass circuit, when two or more of the multiple power sources and the load experience a similar voltage. The connection to the bypass circuit allows the hybrid battery bank to avoid use of the converter when the two or more of the multiple power sources and the load experience a similar voltage or to use the converter to simultaneously charge the supercapacitor and the battery without disconnecting the battery from the load.

Referring back to more general examples, in some exemplary embodiments, a system includes a load and a hybrid battery bank. And, the hybrid battery bank includes power electronics, a supercapacitor, and a battery. In some of such exemplary embodiments, the system also includes a plurality of hybrid battery banks connected in a series arrangement. Also, in some of such exemplary embodiments, the system includes a plurality of hybrid battery banks connected in a parallel arrangement. Also, in some of such exemplary embodiments, the load, the supercapacitor, and the battery are connected to each other through a power conversion circuit. Also, in some of such exemplary embodiments, the system includes additional supercapacitors, additional programmable power electronics, and additional batteries.

With examples including the additional supercapacitors, the additional programmable power electronics, and the additional batteries, the system can further include a plurality of modules, wherein each module includes at least one supercapacitor of the system, at least one set of programmable power electronics of the system, at least one battery of the system. Furthermore, in some of such examples, each battery is separated from other batteries through a respective set of power electronics of each module, and wherein each one of the power electronics of each module independently manages battery operation per defined parameters.

In some of the exemplary embodiments, the power electronics include a buck-boost converter. In some of the examples including the buck-boost converter, the buck-boost converter is a multi-directional buck-boost converter. For example, in some instances, the buck-boost converter is a bidirectional buck-boost converter. Or, for example, in some other instances, the buck-boost converter is a multi-directional buck-boost converter having three or more directions of conversion. Also, in some of the examples including the buck-boost converter, the system further includes multiple power sources connected to the converter. For example, in some instances, the multiple power sources include at least three power sources. Also, in some of the examples including the buck-boost converter, the system further includes multiple power sources, which are parts of the converter.

In some exemplary embodiments, a system includes a load and a hybrid battery bank, wherein the bank includes a buck-boost converter, a supercapacitor, a battery, and one or more optional power sources (such as one or more optional charging sources). In some of such examples, the buck-boost converter is a multi-directional buck-boost converter. And, in some of such instances with the multi-directional buck-boost converter, the buck-boost converter is a bidirectional buck-boost converter. Also, in some of such instances with the multi-directional buck-boost converter, the buck-boost converter is a multi-directional buck-boost converter having three or more directions of conversion.

In some exemplary embodiments, a system includes multiple loads and a hybrid battery bank that includes programmable power electronics, a supercapacitor, a battery, and one or more optional power sources (such as one or more optional charging sources). In some of such examples, the system further includes multiple power sources, and the multiple power sources include at least three power sources, and the multiple loads include at least three loads. Also, in some of such examples, the multiple power sources and the multiple loads are part of a buck-boost converter that is a part of the programmable power electronics. Also, in some of such examples, the multiple power sources and the multiple loads are part of the programmable power electronics. Furthermore, in some embodiments of the system, the converter includes or is connected to a bypass circuit and when two or more of the multiple power sources or loads experience a similar voltage, such components can be directly connected by the bypass circuit.

In some exemplary embodiments, a system includes a load and a hybrid battery bank that includes power electronics, a supercapacitor, a battery, and one or any combination of an optional power source (e.g., an optional charging source) and a load. In some of such examples, the system further includes one or any combination of a plurality of power sources (e.g., a plurality of optional charging sources) and a plurality of loads. Also, in such examples, the load, the supercapacitor, the battery, and the one or any combination of an optional power source (e.g., an optional charging source) and a load can be connected to each other through a power conversion circuit. In some examples with the power conversion circuit, the power conversion circuit is implemented using programmable power electronics. Furthermore, in some embodiments of the system, the power conversion circuit includes or is connected to a bypass circuit and when two or more of the power sources or loads experience a similar voltage, such components can be directly connected by the bypass circuit.

In some exemplary embodiments, a system includes a buck-boost converter and multiple power sources connected to the converter. In some of such exemplary embodiments, the multiple power sources include at least three power sources. And, in some of the aforesaid embodiments, the multiple power sources are part of the converter. Also, in some of such exemplary embodiments, the multiple power sources are part of the converter.

In some exemplary embodiments, a system includes a buck-boost converter and multiple loads connected to the converter. In some of such exemplary embodiments, the multiple loads include at least three loads. And, in some of the embodiments, the multiple loads are part of the converter whether or not the multiple loads include at least three loads. Furthermore, in some embodiments of the system, the converter includes or is connected to a bypass circuit and when two or more of the multiple loads experience a similar voltage, such components can be directly connected by the bypass circuit.

In some exemplary embodiments, a system includes a buck-boost converter and multiple power sources connected to the converter as well as multiple loads connected to the converter. In some of such exemplary embodiments, the multiple power sources include at least three power sources, and wherein the multiple loads include at least three loads. And, in some of the embodiments, the multiple power sources and the multiple loads are part of the converter. Also, in some of the examples, the multiple power sources and the multiple loads are part of the converter. Furthermore, in some embodiments of the system, the converter includes or is connected to a bypass circuit and when two or more of the multiple power sources or loads experience a similar voltage, such components can be directly connected by the bypass circuit.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a predetermined desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and functionality presented herein are not inherently related to any particular computer or other apparatus. Various general-purpose systems can be used with programs in accordance with the teachings herein, or it can prove convenient to construct a more specialized apparatus to perform the methods described herein. The structure for a variety of these systems will appear as set forth herein. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising: a multi-directional buck-boost converter and multiple voltage sources, wherein the multiple voltage sources comprise at least three voltage sources.

2. The system of claim 1, wherein the multiple voltage sources comprises at least one load and at least one power source.

3. The system of claim 2, further comprising a supercapacitor.

4. The system of claim 2, wherein the at least one power source comprises a battery.

5. The system of claim 2, further comprising a bypass circuit, wherein when two or more of the voltage sources experience a similar voltage, such components are directly connected by the bypass circuit.

6. A system, comprising:
a multi-directional buck-boost converter;
multiple voltage sources, wherein the multiple voltage sources comprise at least three voltage sources and the at least three voltage sources comprise at least one load and at least one power source; and
a hybrid battery bank.

7. The system of claim 6, wherein the hybrid battery bank comprises programmable power electronics, a supercapacitor, a battery, and optional power sources.

8. The system of claim 7, wherein the multi-directional buck-boost converter includes or is connected to a bypass circuit, and wherein when two or more of the voltage sources experience a similar voltage such components are directly connected by the bypass circuit.

9. A system, comprising: a load; and a hybrid battery bank, comprising power electronics, a supercapacitor, and a battery.

10. The system of claim 9, comprising a plurality of hybrid battery banks connected in a series arrangement.

11. The system of claim 9, comprising a plurality of hybrid battery banks connected in a parallel arrangement.

12. The system of claim 9, wherein the load, the supercapacitor, and the battery are connected to each other through a power conversion circuit.

13. The system of claim 9, comprising additional supercapacitors, additional programmable power electronics, and additional batteries.

14. The system of claim 13, comprising a plurality of modules, wherein each module comprises at least one supercapacitor of the system, at least one set of programmable power electronics of the system, at least one battery of the system.

15. The system of claim 14, wherein each battery of the system is separated from other batteries through a respective set of power electronics of each module, and wherein each power electronics of each module independently manage battery operation per defined parameters.

16. The system of claim 9, wherein the power electronics comprise a buck-boost converter.

17. The system of claim 16, wherein the buck-boost converter is a multi-directional buck-boost converter.

18. The system of claim 17, wherein the buck-boost converter is a bidirectional buck-boost converter.

19. The system of claim 17, wherein the multi-directional buck-boost converter has three or more directions of conversion.

20. The system of claim 17, wherein the converter includes or is connected to a bypass circuit, and wherein when two or more of voltage sources experience a similar voltage such components are directly connected by the bypass circuit.
